(19) United States
(12) Patent Application Publication
(10) Pub. No.: US 2019/0048454 A1
(43) Pub. Date: Feb. 14, 2019

(54) Abradable Seal Composition for Turbomachine Compressor

(71) Applicant: SAFRAN AERO BOOSTERS SA, Herstal (BE)

(72) Inventor: Laurent Schuster, Erezee (BE)

(73) Assignee: SAFRAN AERO BOOSTERS SA, Herstal (BE)

(21) Appl. No.: 16/102,106

(22) Filed: Aug. 13, 2018

(30) Foreign Application Priority Data
Aug. 14, 2017 (BE) 2017/5556

(51) Int. Cl. C23C 4/06; F01D 11/12; F01D 25/00; C23C 4/134

(52) U.S. Cl. CPC C23C 4/06; F01D 11/122; F01D 25/005; C23C 4/134; F05D 2220/323; F05D 2300/173; F05D 2300/2282; F05D 2230/312; F05D 2240/11; F05D 2240/55

(57) ABSTRACT

A composition for an abradable seal for a turbomachine, in particular in powder form, is able to crumble in the event of contact with a rotor of said turbomachine. The seal is formed on the arcuate wall of a substrate casing. The composition includes a majority metallic phase with a majority by mass of aluminium with some chromium, a minority second phase including a mineral material and/or an organic material.

This application claims priority under 35 U.S.C. § 119 to Belgium Patent Application No. 2017/5556, filed 14 Aug. 2017, titled “Abradable Seal Composition for Turbomachine Compressor,” which is incorporated herein by reference for all purposes.

### BACKGROUND

### 1. Field of the Application

The present application relates to the field of turbomachine sealing using two-phase abradable seals. The present application also proposes a method for creating an abradable seal. The present application also deals with a compressor and an axial-flow turbomachine, in particular a jet engine for an aeroplane or a turboprop for an aircraft.

### 2. Description of Related Art

The mechanical clearances between the tips of rotor blades and the casing surrounding them give rise to leakage that reduces the performance of a turbomachine compressor. In order to reduce this leakage, it is imperative to reduce the distance between the blades and the casing while maintaining a safety margin. Indeed, in the event of contact, both the blades and the casing can be damaged, thus endangering the safe operation of the turbomachine. Such events remain commonplace owing in particular to vibration, ingestion, centrifugal force, expansion and eccentricities of the rotor. Hence, adding a layer of abradable material at the interface between the casing and the blades makes it possible to control the damage in the event of contact since this damage is limited to the material of the seal, which crumbles.

EP3023511A1 discloses a composition for an abradable seal of a turbomachine, the composition comprising an aluminium base, nickel powder and polyester powder. This document also teaches an external casing for a low-pressure compressor of an axial-flow turbomachine with an abradable seal surrounding an annular row of rotor blades. The seal comprises a rounded substrate covered with a layer of abradable material that comprises a metallic phase consisting principally of aluminium, with a smaller proportion of nickel. The abradable material further comprises between 25% and 55% of additive such as polyester, methyl methacrylate, hexagonal boron nitride, calcium fluoride. The substrate is segmented and forms an organic matrix outer casing composite of the compressor. Now, the characteristics of such a seal can be improved. In addition, the seal remains complex to apply.

Although great strides have been made in the area of turbomachine sealing, many shortcomings remain.

### DESCRIPTION OF THE DRAWINGS

FIG. 1 shows an axial-flow turbomachine according to the present application.

FIG. 2 is a diagram of a turbomachine compressor according to the present application.

FIG. 3 illustrates an abradable seal of a turbomachine according to the present application.

FIG. 4 shows a diagram of a method for creating an abradable seal for a turbomachine, according to the present application.

### DETAILED DESCRIPTION OF THE PREFERRED EMBODIMENT

The present application aims to address at least one of the problems presented by the prior art. More specifically, the present application has the object of optimizing the friable nature of the seal. The present application also has the object of proposing a solution that is simple, durable, lightweight, economical, reliable, easy to produce, to maintain and to inspect, and that improves efficiency.

The present application relates to a composition for an abradable seal for a turbomachine, in particular in powder form, said seal being able to crumble in the event of contact with a rotor of said turbomachine, the composition comprising: a metallic phase with a majority by mass of aluminium, a second phase comprising a mineral material and/or an organic material; noteworthy in that the metallic phase further comprises chromium. The metallic phase further comprises nickel. The metallic phase comprises, by mass, more chromium than nickel.

The addition of nickel, which has interesting physical properties, in particular in terms of hardness and toughness, makes it possible to obtain a good compromise between the hardness/toughness of the abradable material and the cost thereof.

According to advantageous embodiments of the present application, the composition may comprise one or more of the following features, taken alone or in any possible technical combination:
the metallic phase comprises, by mass, between 20% and 45% of chromium.
the polymer material comprises polyester and the organic material comprises hexagonal boron nitride.
the metallic phase consists of aluminium and chromium.
the metallic phase represents between 50% and 90% of the mass of the composition.
the metallic phase represents between 82% and 90% of the mass of the composition.
the second phase represents between 10% and 50% of the mass of the composition.
the second phase represents between 10% and 25% of the mass of the composition.
the second phase comprises at least one of the following materials: polyimide, polyamideimide, polyetherimide, bismaleimide, fluoroplastic, a ketone-based resin, liquid crystals of polymers; or any combinations of these.
the second phase comprises at least one of the following materials: molybdenum disulfide, graphite, talc, bentonite, mica; or any combinations of these.

The present application also relates to a composition for an abradable seal for a turbomachine, in particular in powder form, said seal being able to crumble in the event of contact with a rotor of said turbomachine, the composition comprising: a metallic phase with a majority by mass of aluminium, a second phase comprising a mineral material and/or an organic material; noteworthy in that the metallic phase represents between 80% and 90% of the mass of the composition, and/or represents at least: 81%, or 82% or 83% of the mass of the composition.

The present application also relates to a composition for an abradable seal for a turbomachine, in particular in powder form, said seal being able to crumble in the event of contact with a rotor of said turbomachine, the composition comprising: a metallic phase with a majority by mass of aluminium, a second phase comprising a mineral material and/or an organic material; noteworthy in that the mineral material represents: from 10% to 45%, or from 10% to 25% of the mass of the composition.

The present application also relates to a composition for an abradable seal for a turbomachine, in particular in powder form, said seal being able to crumble in the event of contact with a rotor of said turbomachine, the composition comprising: a metallic phase with a majority by mass of aluminium, a second phase comprising a mineral material and/or an organic material; noteworthy in that the organic material represents: from 10% to 45%, or from 10% to 25% of the mass of the composition.

The present application also relates to a composition for an abradable seal for a turbomachine, in particular in powder form, said seal being able to crumble in the event of contact with a rotor of said turbomachine, the composition comprising: a metallic phase with a majority by mass of aluminium, a second phase; noteworthy in that the second phase comprises at least one of the following materials: polyimide, polyamideimide, polyetherimide, bismaleimide, fluoroplastic, a ketone-based resin, liquid crystals of polymers, molybdenum disulfide, graphite, talc, bentonite, mica; or any feasible combination.

The present application also relates to a compressor, for a turbomachine, in particular a low-pressure compressor for a turbomachine, comprising a rotor having rotor blades and an abradable seal that cooperates in a sealing manner with said rotor blades, noteworthy in that the abradable seal comprises a composition in accordance with the present application.

According to advantageous embodiments of the present application, the compressor may comprise one or more of the following features, taken alone or in any possible technical combination:
the compressor comprises an organic matrix composite wall on which is arranged the abradable seal, and an interface between the wall and the abradable seal that is formed by a metallic strip.
the rotor blades cooperating in a sealing manner with the abradable seal are made of titanium.
the rotor blades are configured to operate at a transonic speed.
the radial thickness of the abradable seal is greater than or equal to the average thickness of the rotor blades, and/or greater than or equal to 3.00 mm.
the strip is ferrous, in particular made of steel.
the compactness of the seal made of abradable material is greater than or equal to: 90%, or 95%, or 98%, or 99%.

The present application also relates to a turbomachine, in particular a jet engine, comprising an abradable seal which is noteworthy in that the composition of the abradable seal is in accordance with the present application, the turbomachine may comprise a compressor in accordance with the present application.

The present application also relates to a method for creating an abradable seal for a turbomachine, in particular for a jet engine, the seal comprising an arcuate wall and an abradable composition applied to the arcuate wall, the method comprising the following steps: (a) providing or creating an arcuate wall; (f) applying, by thermal spraying, an abradable seal composition to the arcuate wall, said composition comprising a majority of aluminium in a metallic phase, and a second phase; noteworthy in that at the application step (f) the metallic phase further comprises nickel, possibly at the start and/or at the end of the application step (f) the composition is in accordance with the present application.

According to one advantageous form of the present application, during the application step (f) the composition is applied by plasma spraying.

In general, the advantageous embodiments of each subject of the present application are also applicable to the other subjects of the present application. Each subject of the present application can be combined with other subjects, and the subjects of the present application can also be combined with the embodiments of the description which, moreover, can be combined with one another according to all technically possible combinations, unless the contrary is explicitly stated.

The presence of chromium in the abradable composition provides improved anchoring on a substrate. For example, the cohesion with the metallic strip is improved, in particular bonded to an organic matrix composite casing.

In parallel, the friable behaviour of the abradable material, resulting from the plasma spraying, is increased. This is due in particular to better mixing of the metallic portion and the second portion. Each one of these forms smaller grains than in the prior art. The geometry and the surfaces of the grains may show better interpenetration.

In the following description, the terms “internal” and “external” refer to a position relative to the axis of rotation of an axial-flow turbomachine. The axial direction corresponds to the direction along the axis of rotation of the turbomachine. The radial direction is perpendicular to the axis of rotation. Upstream and downstream refer to the principal flow direction of the flow in the turbomachine.

Metallic phase can be understood as the physical property of the material.

Abradable material is to be understood as a material that will crumble in contact with a rotor element of a turbomachine. This material can be suitable for concentrating therein the wear and the deformation while maintaining the integrity of the rotor.

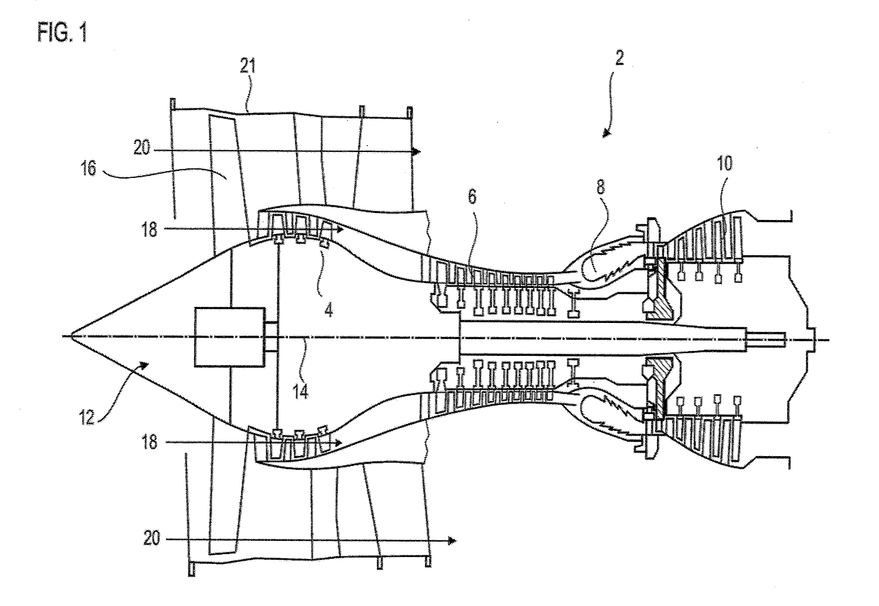

FIG. 1 is a simplified depiction of an axial-flow turbomachine. This specific case is that of a turbofan engine. The jet engine 2 comprises a first compression stage referred to as the low-pressure compressor 4, a second compression stage referred to as the high-pressure compressor 6, a combustion chamber 8 and one or more turbine stages 10. In operation, the mechanical power of the turbine 10, transmitted via the central shaft to the rotor 12, moves the two compressors 4 and 6. The latter comprise multiple rows of rotor blades associated with rows of stator vanes. The rotation of the rotor about its axis of rotation 14 thus makes it possible to generate a flow of air and to progressively compress the latter up to the inlet to the combustion chamber 8.

An intake fan 16 is coupled to the rotor 12 and generates a flow of air which is split into a core flow 18, passing through the various above-mentioned stages of the turbomachine, and a bypass flow 20, passing through an annular duct (shown in part) along the machine so as to then re-join the core flow at the turbine outlet.

The bypass flow can be accelerated so as to produce a thrust reaction which an aeroplane needs to fly. The core flow 18 and bypass flow 20 are coaxial annular flows, one inside the other. They are ducted by the casing of the turbomachine and/or the shrouds. To that end, the casing has cylindrical walls 21 which can be internal and external.

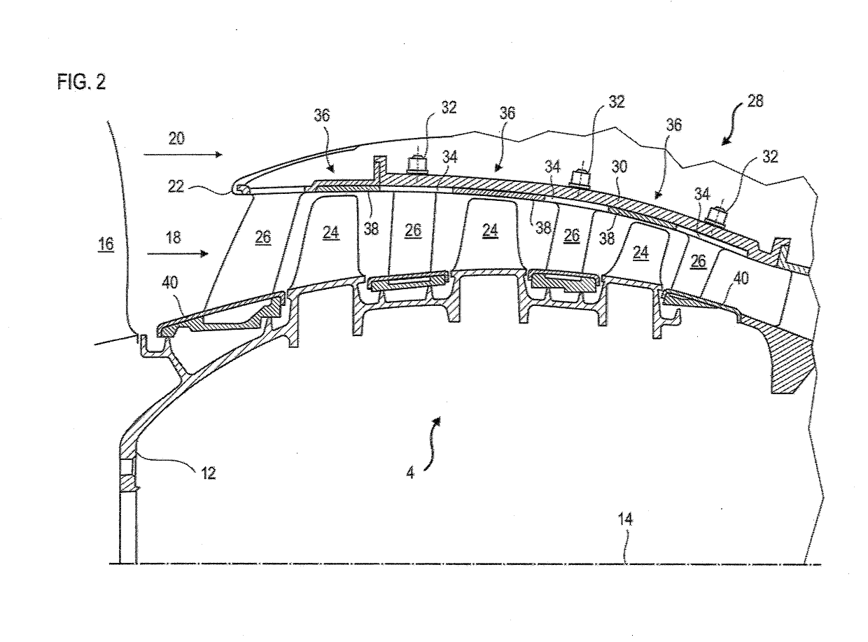

FIG. 2 is a section view of a compressor of an axial-flow turbomachine such as that of FIG. 1. The compressor may be a low-pressure compressor 4. The figure shows a portion of the fan 16 and the splitter 22 for separating the core flow 18 from the bypass flow 20. The rotor 12 comprises multiple rows of rotor blades 24, in this case three.

The low-pressure compressor 4 comprises multiple stators, in this case four, each of which containing one row of stator vanes 26. The orientation of certain stator vanes can be adjusted, in which case these are also referred to as variable-pitch vanes. The stators are associated with the fan 16 or with a row of rotor blades in order to redirect the flow of air so as to convert the velocity of the flow into pressure, in particular into static pressure.

The compressor 4 may comprise an outer casing 28. This casing may comprise an arcuate wall 30. This wall 30 may describe a monolithic closed hoop around the axis of rotation 14, or be formed of half-shells or even semicircles.

The casing 28, and in particular the wall 30 thereof, may be made of an organic matrix composite material. The matrix may be reinforced with fibres, possibly in the form of a preform. The reinforcement may comprise fibrous plies, for example containing carbon fibres or glass fibres.

The stator vanes 26 extend essentially radially from the wall 30, and may be secured and immobilized thereon by means of pins 32. Optionally, the stator vanes 26 comprise securing platforms 34 which may receive the securing pins 32. Both the vanes and the platforms may be made of titanium.

The stator, by its casing 28, receives at least one annular seal 36, possibly an annular seal 36 around each annular row of rotor blades 24. At least one or more annular seals, or each annular seal, 36 may be an abradable seal with an annular layer of abradable material 38. Thus, the seals are abradable seals 36, they help to reduce leakage by making it possible to bring the blades 24 and the casing 28 closer together.

Optionally, inner shrouds 40 are connected to the inner ends of the stator vanes 26. These shrouds 40 may also receive an abradable seal such as described in the present present application, and cooperating with the rotor 12 in a sealed manner.

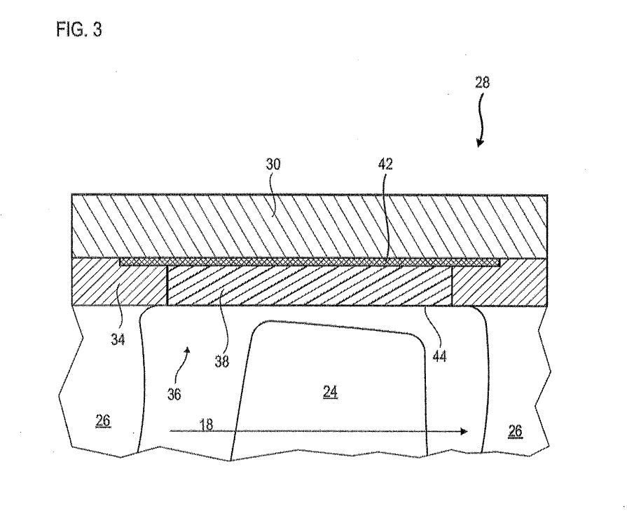

FIG. 3 shows an abradable seal 36 for a compressor such as that of FIG. 2. The figure shows a wall 34 of a casing 28, or substrate 28, an abradable layer 38 of a seal 36 applied thereto, and an end of a rotor blade 24 between two stator vanes 26.

The abradable layer 38 extends from one platform 34, of a vane 26, to the next, this belonging to an adjacent row arranged either upstream or downstream. At least one abradable seal, or each abradable seal, may be in contact with the material of the vane platforms, possibly in electrical contact.

The abradable layer 38 may be applied directly to the wall 30 of the casing 28. Moreover, the seal 36 may comprise an intermediate layer between the substrate and the abradable layer 38. The intermediate layer can be a strip 42 such as sheet steel or sheet nickel. The strip 42 can be perforated and/or cut. It can be of constant thickness. The abradable layer 38 can be thicker than the strip 42.

The strip 42 can be bonded to the wall 30, and/or be held by means of the platforms 34 of the vanes 26. Optionally, the upstream and/or downstream edges of the strip 42 are clamped between the platforms 34 and the wall 30.

The abradable layer 38 has an inner surface 44 in contact with the core flow 18. Its surface 44 guides and bounds the core flow 18 during compression of the latter. It can be flush with the inner surfaces of the platforms 34.

The composition of the material forming the abradable layer 38, and therefore the seal 36, may comprise at least two mingled phases, specifically a metallic phase and a second phase. The second phase may be mineral and/or organic. The abradable material may be composite; and/or granular; and/or with spaces filled by some of its constituents. The second phase may form a lubricant.

The metallic phase comprises, principally, aluminium. The metallic phase of the composition is aluminium-based. That is to say that the greatest mass among the metals of the abradable material is aluminium. The predominance of aluminium optimizes the mass of the seal 36. The metallic phase may also comprise chromium, in a proportion by mass smaller than that of aluminium.

The metallic phase may comprise between 20% and 45% of chromium, and between 55% and 80% of aluminium. The aluminium and the chromium can be the only two metals of which each mass represents at least 0.10% or at least 1% of the mass of the composition. The metallic phase may consist of aluminium and chromium.

Optionally, the metallic phase may also comprise nickel, in particular in a proportion by mass smaller than that of the chromium, for example by a factor of two.

By way of example, the metallic phase may comprise, by mass, 10% chromium and/or 5% nickel; or, by mass, 30% chromium and 10% nickel.

In addition, the metallic phase may possibly comprise iron, copper, zinc, manganese, magnesium and/or impurities; these components represent, individually or in total, between 1% and 0.1% of the mass of the metallic phase.

The organic material of the second phase of the composition may comprise a polymer such as polyester, polyimide, polyamideimide, polyetherimide, bismaleimide, fluoroplastic, a ketone-based resin, liquid crystals of polymers; or any possible combinations of these.

The second phase may also comprise hexagonal boron nitride, calcium fluoride, molybdenum disulfide, graphite, talc, bentonite, mica; or any possible combinations of these. These materials may be considered to be mineral materials.

The second phase may comprise a mixture of at least one mineral material with at least one organic material.

The mass of the second phase may represent: from 5% to 50%, or from 15% to 25%, possibly 20% of the mass of the composition. The metallic phase may represent the majority of the volume of the abradable layer, that is to say that the metallic phase may form a matrix which receives the second phase.

Possibly, the abradable layer may be formed of grains of metallic powders in which the inter-granular spaces are filled with the second phase. Empty space in the abradable layer is less than 1%, preferably less than 0.1%.

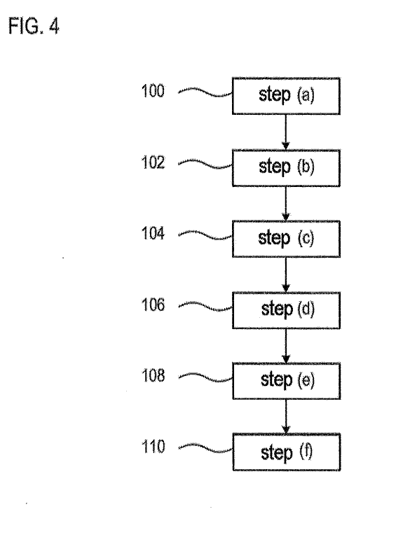

FIG. 4 is a diagram of a method for creating an abradable seal for an axial-flow turbomachine as shown in FIGS. 2 and/or 3. The seal may be used in a compressor, in particular a low-pressure compressor, as set out in relation to FIGS. 1 and/or 2.

The method comprises the following steps, possibly carried out in the following order:

(a)—providing or creating 100 an arcuate wall, such as that of an outer casing of a compressor, said wall acting as a substrate,

(b)—providing or creating 102 stator vanes with platforms;

(c)—providing or creating 104 a strip;

(d)—installing 106 the strip against the casing, in particular against the inner surface of the arcuate wall;

(e)—securing 108 the vanes, via their platforms, against the arcuate wall forming annular rows;

(f)—applying 110 a composition of abradable material to the arcuate wall between the annular rows of platforms so as to cover the strip.

At the start of the step (f) applying 110, the composition has a metallic phase with, principally, aluminium, for example in the form of a powder. The aluminium may be pure or in the form of an alloy. This also applies to the chromium.

The composition may also comprise chromium and possibly a second metal, both in powder form. The mass of chromium represents at least: 20%, or 21%, or 22%, or 23% of the metallic phase. The composition of the powder may match the chemical composition of the abradable layer presented above.

At the end of the step (f) applying 110, at least one or each compound of the composition remains in the form of a powder, or at least one of the compounds has melted, or each compound has melted.

It may be that certain, or at least one, or each type of grain of powder is essentially solid. Each grain can form a homogeneous material. Optionally, one type of grain is a hollow grain, for example the aluminium or chromium grains.

During the step (f) applying 110, the composition can be applied to the casing, that is to say against the arcuate wall, by plasma spraying. A thermal technique of this kind will be well known to a person skilled in the art, it can be carried out in a manner similar to that disclosed in EP 1 010 861 A2. The powder of the second phase can be introduced into the jet of the plasma downstream of the metallic powders. Other techniques are conceivable. Alternatively, the composition can be applied to the substrate by sintering, possibly with prolonged heating. In this alternative, some grains may retain their original shape.

The steps: (b) providing 102 stator vanes; (c) providing or creating 104 a strip; (d) installing 106 the strip against the casing, in particular against the inner surface of the arcuate wall; (e) securing 108 the vanes; are entirely optional according to the present application. Indeed, the composition of abradable material can be applied to a substrate with no vanes or blades, and/or with no strip. For example, the step (f) applying 110 can be carried out in a channel formed in the thickness of the arcuate wall; and/or directly onto the inner surface of the arcuate wall.

The features defined in relation to the composition can apply to the seal, and vice versa.

I claim:

1. Composition for an abradable seal for a turbomachine, said seal being able to crumble in the event of contact with a rotor of said turbomachine, the composition comprising:
a metallic phase with a majority by mass of aluminium; and
a second phase comprising:
a mineral material; and/or
an organic material;
wherein the metallic phase further comprises chromium and nickel, the metallic phase comprising, by mass, more chromium than nickel.

2. Composition according to claim 1, wherein the metallic phase comprises:
by mass, between 20% and 45% of chromium.

3. Composition according to claim 1, wherein the organic material comprises polyester and the mineral material comprises hexagonal boron nitride.

4. Composition according to claim 1, wherein the metallic phase represents between 50% and 90% of the mass of the composition.

5. Composition according to claim 1, wherein the metallic phase represents between 82% and 90% of the mass of the composition.

6. Composition according to claim 1, wherein the second phase constitutes between 10% and 50% of the mass of the composition.

7. Composition according to claim 1, wherein the second phase constitutes between 10% and 25% of the mass of the composition.

8. Composition according to claim 1, wherein the second phase comprises at least one of the following materials:
polyimide, polyamideimide, polyetherimide, bismaleimide, fluoroplastic, a ketone-based resin, liquid crystals of polymers, or any combinations thereof.

9. Composition according to claim 1, wherein the second phase comprises at least one of the following materials:
molybdenum disulfide, graphite, talc, bentonite, mica, or any combinations thereof.

10. Composition for an abradable seal for a turbomachine, in particular in powder form, said seal being able to crumble in the event of contact with a rotor of said turbomachine, the composition comprising:
a first, metallic phase with a majority by mass of aluminium; and
a second phase comprising at least one of the following materials:
polyimide, polyamideimide, polyetherimide, bismaleimide, fluoroplastic, a ketone-based resin, liquid crystals of polymers, molybdenum disulfide, graphite, talc, bentonite, mica, or any feasible combination thereof.

11. Method for creating an abradable seal for a jet engine, the seal comprising an arcuate wall and an abradable composition applied to the arcuate wall, the method comprising:
providing or creating an arcuate wall;
applying, by thermal spraying, an abradable seal composition to the arcuate wall, said composition comprising:
a metallic phase with a majority of aluminium; and
a second phase comprising a mineral material and/or an organic material, the metallic phase further comprising chromium and nickel, the metallic phase comprising, by mass, more chromium than nickel.

12. Method according to claim 11, wherein during the application step the composition is applied by plasma spraying.
